(19) United States
(12) Patent Application Publication
(10) Pub. No.: US 2012/0255395 A1
(43) Pub. Date: Oct. 11, 2012

(54) TORQUE ROD

(75) Inventors: Hideki Sugawara, Yokohama-shi (JP); Yoshichika Okajima, Yokohama-shi (JP)

(73) Assignee: BRIDGESTONE CORPORATION, Chuo-ku, Tokyo (JP)

(21) Appl. No.: 13/497,728

(22) PCT Filed: Sep. 24, 2010
(86) PCT No.: PCT/JP2010/005772

§ 371 Date: Jun. 29, 2012

(30) Foreign Application Priority Data
Sep. 25, 2009 (JP) 2009-221162

(51) Int. Cl. F16C 7/02

(52) U.S. Cl. 74/579 R

(57) ABSTRACT

Provided is a torque rod capable of reducing the yield rate while enhancing the strength of an outer cylinder of a bush. The torque rod includes a large-diameter bush 5 and a small-diameter bush 6 connected to each other by a linkage member 4 and each having an inner cylinder 2 and an outer cylinder 7, 8, the large-diameter bush and the small-diameter bush having mutually perpendicular axial directions. The linkage member 4 is formed as a combinedly joined body obtained by plastically fabricating two metal plates, and the large-diameter bush 5 is provided with a protrusion 9 on an outer periphery of the outer cylinder.

### TECHNICAL FIELD

The present invention relates to a torque rod for a vehicle, and in particular to a torque rod that has excellent durability and manufacturability.

### RELATED ART

Conventional torque rods have been formed, for example, such that a pair of bushes each having a metallic inner cylinder and an outer cylinder connected to an outer peripheral surface of the inner cylinder by a rubber member are coupled integrally to each other by a linkage member.

As an example of a technique of reducing the number of constituent elements of the torque rod and the number processes, Patent Document 1 proposes a technique in which an outer cylinder of a larger bush, an outer cylinder of a smaller bush, and a linkage portion are formed such that one ring-shaped metal plate is subjected to a press shaping to integrally form a pair of the outer cylinders and the linkage portion, and the linkage portion where two portions of the sheet overlap each other is jointed through spot welding.

However, such a torque rod is formed by bending a ring-shaped metal plate through the press shaping, so that the strength of the outer cylinder of the larger bush particularly decreases, which possibly causes reduction in the resistance force against the tension acting in the direction that the diameter of the bush increases.

In particular, for a torque rod including a pair of bushes having mutually perpendicular axial directions, the outer cylinder of the large-diameter bush is desired to have improved strength so as to reduce the vibration acting in a rolling direction due to torque from a member located on the vibration-generating side.

### RELATED ART DOCUMENT

### Patent Document

Patent Document 1: Japanese Patent Application Laid-open No. 2008-2615

### DISCLOSURE OF THE INVENTION

### Problems To Be Solved By the Invention

In view of the circumstances described above, an object of the present invention is to provide a torque rod including a pair of bushes having mutually perpendicular axial directions, which is capable of particularly enhancing the strength of the outer cylinder of a large-diameter bush.

### Means For Solving the Problem

A torque rod according to the present invention includes a large-diameter bush and a small-diameter bush connected to each other by a linkage member and each having an inner cylinder and an outer cylinder, the large-diameter bush and the small-diameter bush having mutually perpendicular axial directions, wherein the linkage member is formed as a combinedly joined body obtained by plastically fabricating two metal plates, and the large-diameter bush is provided with a protrusion on an outer periphery of the outer cylinder.

In the torque rod described above, it is preferable that the outer cylinder of the large-diameter bush is formed by bending the metal plates.

Further, it is preferable that the outer cylinder of the small-diameter bush is formed by drawing the metal plates.

Yet further, it is preferable that the linkage member has a hollow portion extending along the longitudinal direction of the linkage member.

### Effect of the Invention

The torque rod according to the present invention has the linkage member formed as a combinedly joined body obtained by plastically fabricating two metal plates, and the large-diameter bush is provided with the protrusion on an outer periphery of the outer cylinder so that it is possible to enhance the strength of the outer cylinder, and to improve the rigidity of the outer cylinder in the direction that the diameter of the outer cylinder increases due to vibration or torque from the member on the vibration-generating side.

### BRIEF DESCRIPTION OF THE DRAWINGS

FIG. 1 is a side view illustrating an embodiment of a torque rod according to the present invention.

FIG. 2 is a sectional perspective view illustrating a part of each bush of the torque rod illustrated in FIG. 1.

FIG. 3 is a diagram illustrating forces acting on an inner cylinder of the torque rod.

FIG. 4 is a plan view illustrating another embodiment of the torque rod according to the present invention.

FIG. 5 is a plan view illustrating another embodiment of the torque rod according to the present invention.

FIG. 6 is a side view illustrating a conventional torque rod.

### BEST MODE FOR CARRYING OUT THE INVENTION

Hereinbelow, a torque rod according to the present invention will be described in detail with reference to the drawings.

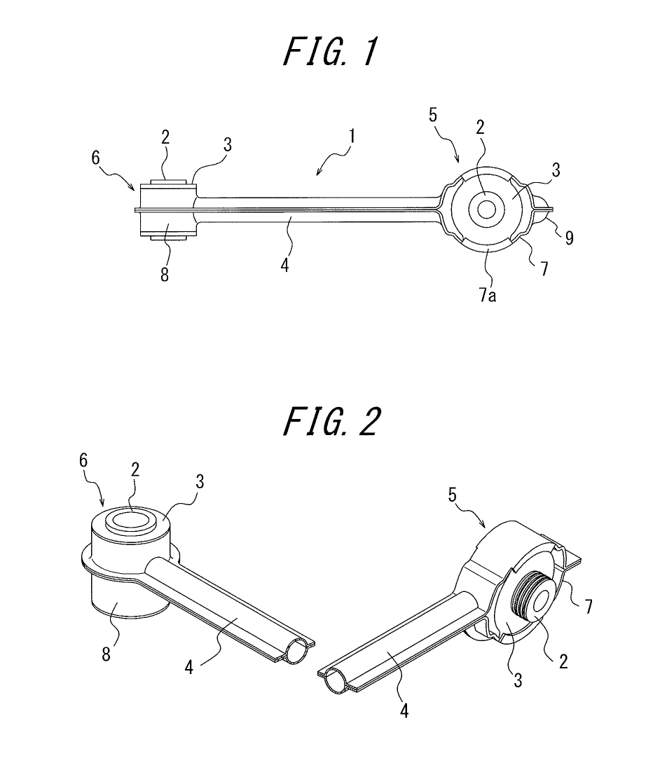

FIG. 1 is a side view illustrating an embodiment of a torque rod according to the present invention. FIG. 2 is a sectional perspective view illustrating a part of each bush of the torque rod.

A torque rod 1 in the drawings has a pair of cylindrical bushes each having a metallic inner cylinder 2, a rubber member 3 surrounding a periphery of the inner cylinder, and a metallic outer cylinder. The bushes are connected to each other by a linkage member 4.

The pair of bushes comprise a large-diameter bush 5 and a small-diameter bush 6, each of which has different diameters. The bushes 5 and 6 are connected so as to have mutually perpendicular axial directions.

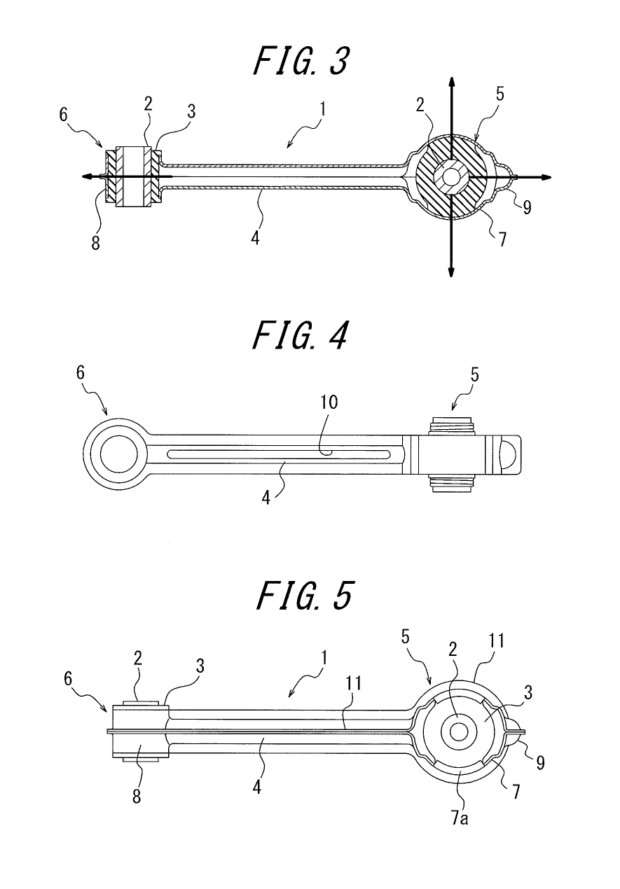

The large-diameter bush 5 may be formed by directly adhering the rubber member 3 to the entire surface of the inner cylinder 2 and the outer cylinder 7 (top and bottom of the outer cylinder 7 in the drawings) through vulcanization, or press fitting the rubber member 3 into the outer cylinder 7. Further, the outer cylinder 7 may have folded portions 7a located at the top and bottom thereof in the drawing for sandwiching and holding the rubber member 3. With the folded portions 7a, the detachment of the rubber member can be prevented. As illustrated in FIG. 3, the strength of the linkage member 4 may be enhanced in the extending direction to particularly prevent change in the accommodation sizes of an outer cylinder 8 that accommodates the rubber member 3. In the small-diameter bush 6, the rubber member 3 is directly fixed entirely to the inner cylinder 2 and the outer cylinder 8 through vulcanization adhesion.

According to the torque rod 1 as described above, the rubber member 3 can absorb or alleviate the transmission of vibration and the like at the time of rotary driving, for example, from the inner cylinder side to the outer cylinder side. In this case, with the function of the linkage member 4, the outer cylinder provides resistance force against a force acting in a direction in which the inner cylinders recede from each other, and a force acting in a direction in which the inner cylinders approach to each other.

The linkage member 4 and the outer cylinders 7, 8 of the torque rod 1 are formed by plastically fabricating two sheets of metal plates to have desired shapes, and welding them into a combinedly jointed body. Thus, there is no need to connect the outer cylinders and the linkage member. This enables reduction in the number of parts and eliminating the operation such as positioning of parts, so that the cost can be reduced.

In the torque rod 1, a protrusion 9 is formed on the outer periphery of the outer cylinder 7 of the large-diameter bush 5, in the drawing, at a position opposite to the linkage member 4. With this configuration, it is possible to enhance the rigidity of the outer cylinder 7 to generate the resistant force against the tensile force of the inner cylinder 2 in various directions as illustrated in FIG. 3.

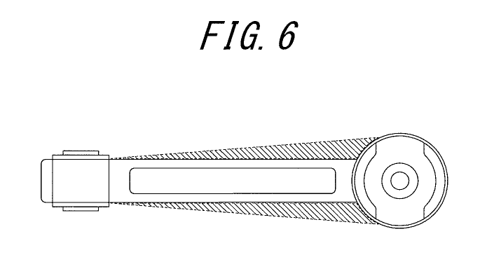

With the conventional torque rod having an outer cylinder of a large-diameter bush formed through a drawing process as illustrated in FIG. 6 to enhance the reinforcement of the outer cylinder 7 of the large-diameter bush 5, a metal plate used for forming the large-diameter outer cylinder is particularly drawn in the drawing process, and hence, it is necessary to reserve the drawn portion, and to cut the unnecessary area, which is the hatched area in FIG. 6, after the drawing process. This increases the yield loss of the material. Further, in the case where the outer cylinder of the bush is formed by using a pipe member having high strength, the material cost inevitably increases.

For the reasons described above, it is more preferable that, in the torque rod 1, the outer cylinder 7 of the large-diameter bush 5 is provided with steps formed by bending the metal plates. The bending process can be performed by sequentially bending several portions of the metal plate in the longitudinal direction, for example, with a press brake, or folding them in the axial direction to form the folded portions 7a.

With this configuration, the amount of drawing of the metal plates can be reduced in the outer cylinder 7 of the large-diameter bush 5 as compared with the outer cylinder of the large-diameter bush formed through the conventional drawing process, so that the yield rate of the materials improves, and the cost reduces.

Preferably, by forming the outer cylinder 8 of the small-diameter bush 6 through the drawing process so as to have the above-described configuration, the yield rate can improve, stopping of shaft rotation of the large-diameter bush 5 can be avoided, and the bush detachment in the axial direction can be prevented. Further, with the protrusion 9, it is possible to improve the rigidity between the large-diameter bush 5 and the small-diameter bush 6. The drawing process can be performed, for example, by fastening the outer periphery of the flat metal plates to form a seamless container-like member having a bottom.

FIG. 4 is a side view illustrating another embodiment of the torque rod according to the present invention. In this embodiment, a hollow portion 10 is formed at a given position along the longitudinal direction of the linkage member 4 as large as possible by taking the strength of the linkage member 4 into consideration. With this hollow portion 10, the material can be reduced, and the weight of the torque rod can be reduced.

The torque rod 1 can be obtained, for example, by press forming two metal plates to form an outer cylinder of a predetermined small-diameter bush through drawing and to form an outer cylinder of a predetermined large-diameter bush through bending simultaneously; welding them in a position that they face each other; and press fitting the inner cylinder and the rubber member of each bush into a drawing portion and a bending portion of a two-press welding bracket.

FIG. 5 is a side view illustrating another embodiment of the torque rod according to the present invention. In this embodiment, a rib 11 is formed such that the rib 11 extending from the outer cylinder 7 to the linkage member 4 protrudes from the outer periphery, and the linkage member 4 has four ribs 11 at 90° intervals in the circumferential direction. With this configuration, it is possible to enhance the rigidity of the outer cylinder 7 to increase the resistance force against the tensile force in various directions of the inner cylinder 2 as illustrated in FIG. 3, and to enhance the section modulus of the metal plate of the outer cylinder 7 and the linkage member 4 located particularly at the connection portion to increase the rigidity thereof.

### EXPLANATION OF REFERENCE CHARACTERS

1 Torque rod

2 Inner cylinder

3 Rubber member

4 Linkage member

5 Large-diameter bush

6 Small-diameter bush

7, 8 Outer cylinder

7a Folded portion

9 Protrusion

10 Hollow portion

11 Rib

1. A torque rod including a large-diameter bush and a small-diameter bush connected to each other by a linkage member and each having an inner cylinder and an outer cylinder, said large-diameter bush and said small-diameter bush having mutually perpendicular axial directions, wherein
the linkage member is formed as a combinedly jointed body obtained by plastically fabricating two metal plates, and
the large-diameter bush is provided with a protrusion on an outer periphery of the outer cylinder of the large-diameter bush is formed.

2. The torque rod according to claim 1, wherein
the outer cylinder of the large-diameter bush is formed by bending the metal plates.

3. The torque rod according to claim 1, wherein
the outer cylinder of the small-diameter bush is formed by drawing the metal plates.

4. The torque rod according to claim 1, wherein
the linkage member has a hollow portion extending along the longitudinal direction of the linkage member.
